(19) United States
(12) Patent Application Publication
(10) Pub. No.: US 2026/0351204 A1
(43) Pub. Date: Nov. 5, 2026

(54) SCREEN DISPLAY METHOD AND APPARATUS, DEVICE, AND STORAGE MEDIUM

(71) Applicants: ZHEJIANG ZEEKR INTELLIGENT TECHNOLOGY CO., LTD., Ningbo (CN); ZHEJIANG GEELY HOLDING GROUP CO., LTD., Hangzhou (CN)

(72) Inventors: Tianze MA, Ningbo (CN); Weidong SUN, Ningbo (CN)

(73) Assignees: ZHEJIANG ZEEKR INTELLIGENT TECHNOLOGY CO., LTD., Ningbo (CN); ZHEJIANG GEELY HOLDING GROUP CO., LTD., Hangzhou (CN)

(21) Appl. No.: 19/708,718

(22) Filed: Jun. 15, 2026

Related U.S. Application Data
(63) Continuation of application No. PCT/CN2025/079612, filed on Feb. 27, 2025.

(30) Foreign Application Priority Data
Mar. 21, 2024 (CN) 202410328177.8

(51) Int. Cl. G09G 3/34; B60K 35/22; B60K 35/29; G06F 3/01; G09G 3/3208

(52) U.S. Cl. CPC G09G 3/3406; B60K 35/22; B60K 35/29; G06F 3/013; G09G 3/3208; B60K 2360/741; G09G 2320/046; G09G 2320/0626; G09G 2354/00; G09G 2380/10

(57) ABSTRACT

A screen display method is applied to a vehicle-mounted display screen. The method includes: dynamically obtaining a display image of a target display screen, the display image being displayed in a first display region of the target display screen; in response to determining that the display image satisfies a preset static image movement condition, controlling the display image to move toward a second display region of the target display screen, the second display region including a plurality of unoccupied pixels configured to display the display image.

### CROSS-REFERENCE TO RELATED APPLICATIONS

This application is a continuation application of International Application No. PCT/CN2025/079612, filed on Feb. 27, 2025, which claims priority to Chinese Patent Application No. 202410328177.8, filed on Mar. 21, 2024. All of the aforementioned applications are incorporated herein by reference in their entireties.

### TECHNICAL FIELD

The present application relates to the technical field of screen display, and in particular, to a screen display method, a screen display apparatus, a device, and a storage medium.

### BACKGROUND

With the development of display technology, more and more types of display devices have appeared in the market. Following Cathode Ray Tube (CRT) displays, Liquid Crystal Display (LCD) displays, and Light-Emitting Diode (LED) displays, Organic Light-Emitting Diode (OLED) displays have emerged. Since OLED display screens have advantages such as being light and thin, having a high color gamut, and high contrast, they are increasingly adopted by more and more television products.

OLED belongs to a current-type organic light-emitting device, and it produces a phenomenon of emitting light through the injection and recombination of charge carriers. The light-emitting intensity is directly proportional to the injected current, and the display principle is that organic materials emit fluorescence under the action of an electric field for display. In the usage process, the brightness of the pixel dots at the screen will slowly decay as the usage time increases. Limited by the display image, the brightness decay degrees of pixel dots at different positions are different. After a period of time, the brightness differences among the pixel dots at different positions will cause an image retention phenomenon, which is commonly referred to as burn-in.

The above content is only to assist in understanding the technical solutions of the present application, and does not represent an admission that the above content is the related art.

### SUMMARY

The main objective of the present application is to provide a screen display method, a screen display apparatus, a device, and a storage medium, which aims to solve the technical problem that conventional OLED display screens have the burn-in phenomenon.

To achieve the above objective, the present application provides a screen display method. The screen display method is applied to a vehicle-mounted display screen. The method includes:
dynamically obtaining a display image of a target display screen, the display image being displayed in a first display region of the target display screen; and
controlling the display image to move toward a second display region of the target display screen in response to determining that the display image satisfies a preset static image movement condition, the second display region including a plurality of unoccupied pixels for displaying the display image.

In an embodiment, before the controlling the display image to move toward the second display region of the target display screen in response to determining that the display image satisfies the preset static image movement condition, the method further includes:
determining a pixel change rate of the display image within a preset continuous duration;
determining whether the pixel change rate is greater than a preset change rate threshold;
in response to that the pixel change rate is greater than the preset change rate threshold, determining that the display image does not satisfy the static image movement condition; and
in response to that the pixel change rate is not greater than the preset change rate threshold, determining that the display image satisfies the static image movement condition.

In an embodiment, the controlling the display image to move toward the second display region of the target display screen includes:
generating a plurality of movement paths for the display image moving toward the second display region according to a pixel quantity of the first display region and a pixel quantity of the second display region;
determining a movement pixel change rate of the display image moving based on each movement path;
determining a target path among the movement paths according to the movement pixel change rate, the target path being a movement path corresponding to a maximum value of the movement pixel change rate; and
controlling the display image to move toward the second display region based on the target path.

In an embodiment, the target display screen is provided with an eye tracking module, and the controlling the display image to move toward the second display region of the target display screen includes:
obtaining a first quantity of visual gaze points of the target display screen collected by the eye tracking module;
determining a target movement speed of the display image according to the first quantity of the visual gaze points, the first quantity of the visual gaze points being negatively correlated with the target movement speed; and
controlling the display image to move toward the second display region based on the target movement speed.

In an embodiment, the determining the target movement speed of the display image according to the first quantity of the visual gaze points includes:
determining whether the first quantity of the visual gaze points is zero;
in response to that the first quantity of the visual gaze points is not zero, obtaining the target movement speed corresponding to the first quantity of the visual gaze points according to a preset mapping relationship between a visual gaze point quantity and an image movement speed; and
in response to that the first quantity of the visual gaze points is zero, determining the target movement speed according to a first continuous duration during which the first quantity of the visual gaze points is zero, and the first continuous duration is positively correlated with the target movement speed.

In an embodiment, the target display screen is provided with an eye tracking module, and after the controlling the display image to move toward the second display region of the target display screen, the method further includes:
obtaining a second quantity of visual gaze points of the target display screen collected by the eye tracking module;
in response to that the second quantity of the visual gaze points is zero, determining a target brightness reduction rate of the target display screen according to a second continuous duration during which the second quantity of the visual gaze points is zero, the second continuous duration being positively correlated with the target brightness reduction rate; and
controlling the target display screen to gradually reduce a display brightness based on the target brightness reduction rate.

In an embodiment, the determining the target brightness reduction rate of the target display screen according to the second continuous duration during which the second quantity of the visual gaze points is zero includes:
obtaining the target brightness reduction rate corresponding to the second continuous duration according to a preset mapping relationship between the zero-gaze continuous duration and a brightness reduction rate.

The present application further provides a screen display apparatus, including:
an obtaining module configured to dynamically obtain a display image of a target display screen, the display image being displayed in a first display region of the target display screen; and
a control module configured to control the display image to move toward a second display region of the target display screen in response to determining that the display image satisfies a preset static image movement condition, the second display region including a plurality of unoccupied pixels for displaying the display image.

The present application further provides an electronic device, including: a memory, a processor, and a screen display program stored in the memory and executable on the processor, the screen display program is configured to implement the screen display method as described above.

The present application further provides a storage medium, the storage medium is a computer-readable storage medium, a screen display program is stored in the storage medium, and the screen display program, when executed by a processor, implements the screen display method as described above.

The present application discloses a screen display method. The screen display method is applied to a vehicle-mounted display screen. The method includes: dynamically obtaining a display image of a target display screen, the display image being displayed in a first display region of the target display screen; and controlling the display image to move toward a second display region of the target display screen in response to determining that the display image satisfies a preset static image movement condition, the second display region including a plurality of unoccupied pixels for displaying the display image. Through a pre-division of the display regions of the vehicle-mounted display screen, an actual display region (namely, the first display region) configured to display the display image, as well as a to-be-displayed region (namely, the second display region) similarly capable of being configured to display the display image but with unoccupied pixels, are obtained. Further, in response to determining that the display image satisfies the preset static image movement condition, that is, when at least a part of the static image exists in the display image and there is a certain burn-in risk, automatically controlling the display image to move toward the second display region reserved in the target display screen. Since one of the reasons for the burn-in situation of the OLED display screen is that the pixel dots at the display screen stay lit for a long time and the brightness remains unchanged, thereby resulting in different brightness decay degrees of each pixel dot at the display screen. Therefore, through the pre-division of the regions, a movable region is provided for the display image. Further, when a burn-in risk exists, that is, the preset static image movement condition is satisfied, the display image is controlled to move within the second display region of the target display screen; so that at least some of the pixels of the target display screen have a change in brightness caused by the movement, thereby effectively avoiding the occurrence of the burn-in situation of the display screen.

### BRIEF DESCRIPTION OF THE DRAWINGS

FIG. 1 is a structural schematic diagram of an electronic device in a hardware running environment involved in an embodiment of the present application.

FIG. 2 is a flowchart schematic diagram of a screen display method involved i first embodiment of the present application.

FIG. 3 is a first schematic diagram of a target screen involved in the first embodiment of the present application.

FIG. 4 is a second schematic diagram of the target screen involved in the first embodiment of the present application.

FIG. 5 is a third schematic diagram of the target screen involved in the first embodiment of the present application.

FIG. 6 is a fourth schematic diagram of the target screen involved in the first embodiment of the present application.

FIG. 7 is a movement schematic diagram of a display image involved in the first embodiment of the present application.

FIG. 8 is a framework structure schematic diagram of a screen display apparatus involved in an embodiment of the present application.

FIG. 9 is a flowchart schematic diagram of determining whether a display image satisfies a static image movement condition involved in the first embodiment of the present application.

FIG. 10 is a flowchart schematic diagram of determining a target path for a display image involved in the second embodiment of the present application.

FIG. 11 is a flowchart schematic diagram of determining a target movement speed based on visual gaze points involved in the second embodiment of the present application.

FIG. 12 is a flowchart schematic diagram of determining a target brightness reduction rate and gradually reducing display brightness involved in the third embodiment of the present application.

The realization of the objectives, functional characteristics, and advantages of the present application will be further described in conjunction with the embodiments and with reference to the accompanying drawings.

### DETAILED DESCRIPTION OF THE EMBODIMENTS

It should be understood that the specific embodiments described herein are only configured to explain the present application, and are not configured to limit the present application.

In addition, descriptions involving “first”, “second”, etc. in the present application are only configured for descriptive purposes, and cannot be understood as indicating or implying their relative importance or implicitly indicating the quantity of the indicated technical features. Thus, features specified with “first” or “second” may explicitly or implicitly include at least one such feature. In addition, “and/or” in the entire text includes three solutions. Taking A and/or B as an example, it includes the technical solution A, the technical solution B, and the technical solution satisfying both A and B. In addition, the technical solutions among various embodiments can be combined with each other, but it must be based on the ability of a person of ordinary skill in the art to implement them. When the combination of technical solutions shows mutual contradictions or cannot be implemented, it should be considered that such a combination of technical solutions does not exist and is not within the protection scope requested by the present application.

Referring to FIG. 1, FIG. 1 is a structural schematic diagram of an electronic device in a hardware running environment involved in an embodiment of the present application.

As shown in FIG. 1, the electronic device may include: a processor 1001, such as a Central Processing Unit (CPU), a communication bus 1002, a user interface 1003, a network interface 1004, and a memory 1005. The communication bus 1002 is configured to realize connection and communication among these components. The user interface 1003 may include a display and an input unit such as a keyboard. The user interface 1003 may further include standard wired interfaces and wireless interfaces. The network interface 1004 may include standard wired interfaces and wireless interfaces (such as a Wireless-Fidelity (WI-FI) interface). The memory 1005 may be a high-speed Random Access Memory (RAM), or it may be a stable Non-Volatile Memory (NVM), such as a disk storage. The memory 1005 may also be a storage device independent of the aforementioned processor 1001.

Those skilled in the art can understand that the structure shown in FIG. 1 does not constitute a limitation to the electronic device, and may include more or fewer components than those shown in the figure, or a combination of some components, or a differently arranged components.

As shown in FIG. 1, the memory 1005 as a type of storage medium may include an operating system, a data storage module, a network communication module, a user interface module, and a screen display program.

In the electronic device shown in FIG. 1, the network interface 1004 is mainly configured to perform data communication with other devices; the user interface 1003 is mainly configured to perform data interaction with a user; the processor 1001 and the memory 1005 in the electronic device of the present application can be provided at the electronic device. The electronic device calls the screen display program stored in the memory 1005 through the processor 1001, and performs the following operations:
dynamically obtaining a display image of a target display screen. The display image is displayed in a first display region of the target display screen; and
controlling the display image to move toward a second display region of the target display screen in response to determining that the display image satisfies a preset static image movement condition. The second display region includes a plurality of unoccupied pixels configured to display the display image.

Further, the processor 1001 can call the screen display program stored in the memory 1005 and also performs the following operations:
before the controlling the display image to move toward the second display region of the target display screen in response to determining that the display image satisfies the preset static image movement condition, the method further includes:
determining a pixel change rate of the display image within a preset continuous duration;
determining whether the pixel change rate is greater than a preset change rate threshold;
in response to that the pixel change rate is greater than the preset change rate threshold, determining that the display image does not satisfy the static image movement condition; and
in response to that the pixel change rate is not greater than the preset change rate threshold, determining that the display image satisfies the static image movement condition.

Further, the controlling the display image to move toward the second display region of the target display screen includes:
generating a plurality of movement paths for the display image moving toward second display region according to a pixel quantity of the first display region and a pixel quantity of the second display region;
determining a movement pixel change rate of the display image moving based each movement path;
determining a target path among the movement paths according to the movement pixel change rate, the target path being a movement path corresponding to a maximum value of the movement pixel change rate; and
controlling the display image to move toward the second display region based on the target path.

Further, the target display screen is provided with an eye tracking module. The controlling the display image to move toward the second display region of the target display screen includes:
obtaining a first quantity of visual gaze points of the target display screen collected by the eye tracking module;
determining a target movement speed of the display image according to the first quantity of the visual gaze points, the first quantity of the visual gaze points being negatively correlated with the target movement speed; and
controlling the display image to move toward the second display region based on the target movement speed.

Further, the determining the target movement speed of the display image according to the first quantity of the visual gaze points includes:
determining whether the first quantity of the visual gaze points is zero;
in response to that the first quantity of the visual gaze points is not zero, obtaining the target movement speed corresponding to the first quantity of the visual gaze points according to a preset mapping relationship between a visual gaze point quantity and an image movement speed; and
in response to that the first quantity of the visual gaze points is zero, determining the target movement speed according to a first continuous duration during which the first quantity of the visual gaze points is zero, the first continuous duration being positively correlated with the target movement speed.

Further, the processor 1001 can call the screen display program stored in the memory 1005 and also performs the following operations:
the target display screen is provided with an eye tracking module. After the controlling the display image to move toward the second display region of the target display screen, the method further includes:
obtaining a second quantity of visual gaze points of the target display screen collected by the eye tracking module;
in response to that the second quantity of the visual gaze points is zero, determining a target brightness reduction rate of the target display screen according to a second continuous duration during which the second quantity of the visual gaze points is zero, the second continuous duration being positively correlated with the target brightness reduction rate; and
controlling the target display screen to gradually reduce a display brightness based on the target brightness reduction rate.

Further, the determining the target brightness reduction rate of the target display screen according to the second continuous duration during which the second quantity of the visual gaze points is zero includes:
obtaining the target brightness reduction rate corresponding to the second continuous duration according to a preset mapping relationship between a zero-gaze continuous duration and a brightness reduction rate.

Based on the above structure, various embodiments of the screen display method are provided.

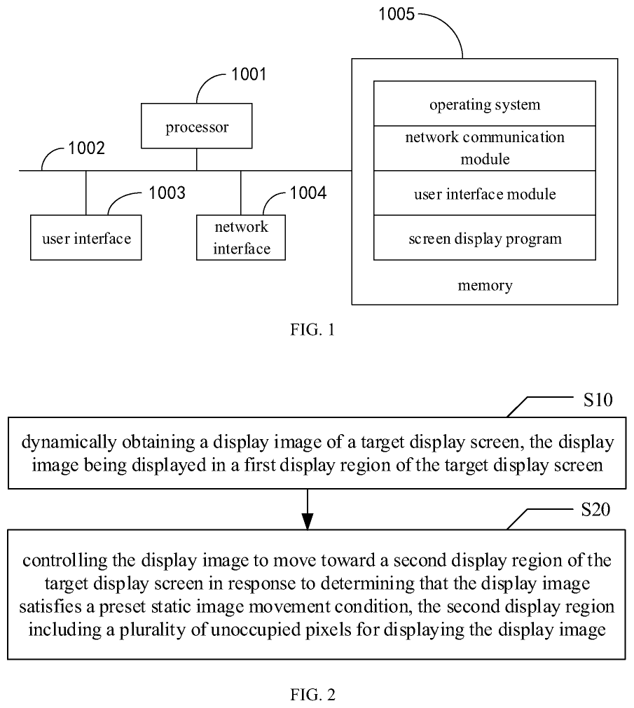

Referring to FIG. 2, FIG. 2 is a flowchart schematic diagram of a first embodiment of the screen display method of the present application.

In this embodiment, an execution subject of the screen display method may be electronic device. The electronic device may be a local device, such as a vehicle's central control system or an Electronic Control Unit (ECU), and may also be a network device, which is not limited in this embodiment. Hereinafter, for the convenience of description, the elaboration of each embodiment is performed by omitting the execution subject. In this embodiment, the screen display method is applied to a vehicle-mounted display screen. The screen display method includes following steps.

Step S10, dynamically obtaining a display image of a target display screen, the display image being displayed in a first display region of the target display screen.

In a feasible embodiment, in order to effectively solve the burn-in problem existing in the OLED display screen, regions of the vehicle-mounted display screen are pre-divided to obtain an actual display region (namely, the first display region) configured to display the display image, and a to-be-displayed region (namely, the second display region) which is similarly capable of being configured to display the display image but with unoccupied pixels. Thus, the display image of each vehicle-mounted display screen is displayed in the first display region by default. To further determine whether the display screen has a burn-in risk, the display image of the target display screen is dynamically obtained.

The target display screen is any display screen among the vehicle-mounted display screens. For example, the vehicle-mounted display screens can be divided according to position, function, etc., and at least include: an instrument display screen, a central control display screen, an entertainment display screen, etc.

The number of the first display regions of the target display screen may be one or more. The plurality of first display regions may be adjacent or not adjacent. The number of the second display regions of the target display screen may be one or more. The plurality of second display regions may be adjacent or not adjacent.

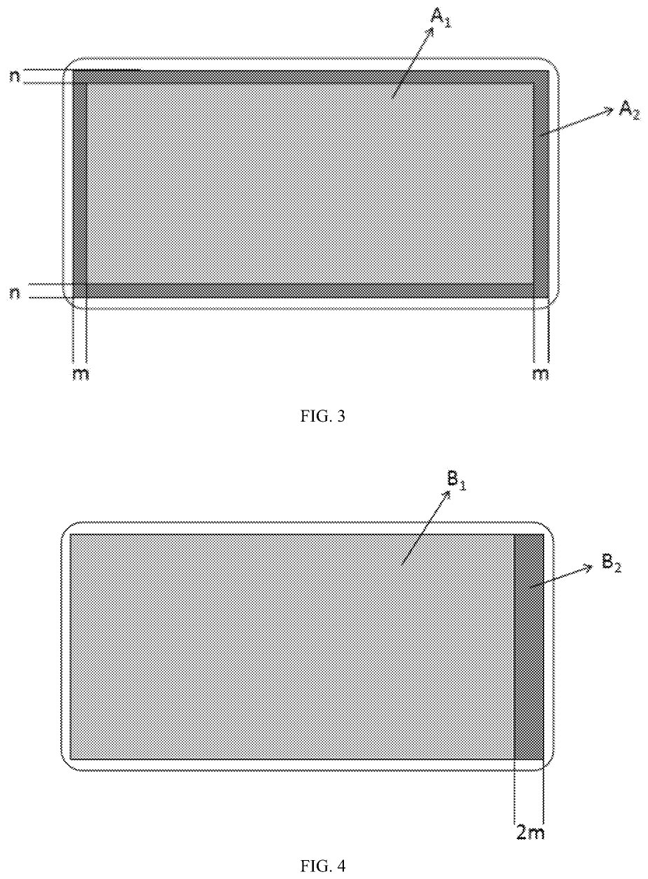

Exemplarily, referring to FIG. 3, a resolution of the target display screen is X*Y, which means that all pixels X*Y are occupied during full-screen display. Further, the display region of the target display screen is divided to obtain a first display region A₁, whose occupied pixel rate is (X−2m)*(Y−2n). The remaining unoccupied pixels constitute a second display region A₂.

Exemplarily, referring to FIG. 4, a resolution of the target display screen is X*Y, which means that all pixels X*Y are occupied during full-screen display. Further, the display region of the target display screen is divided to obtain a first display region B₁, whose occupied pixel rate is (X−2m)*Y. The remaining unoccupied pixels constitute a second display region B₂.

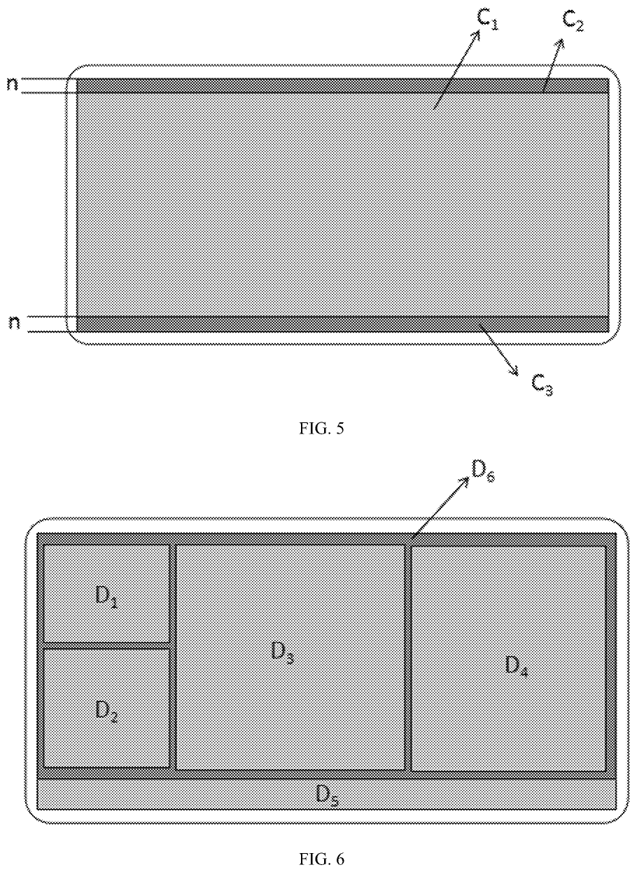

Exemplarily, referring to FIG. 5, a resolution of the target display screen is X*Y, which means that all pixels X*Y are occupied during full-screen display. Further, the display region of the target display screen is divided to obtain a first display region C₁, whose occupied pixel rate is X*(Y−2n). The remaining unoccupied pixels constitute two second display regions C₂ and C₃.

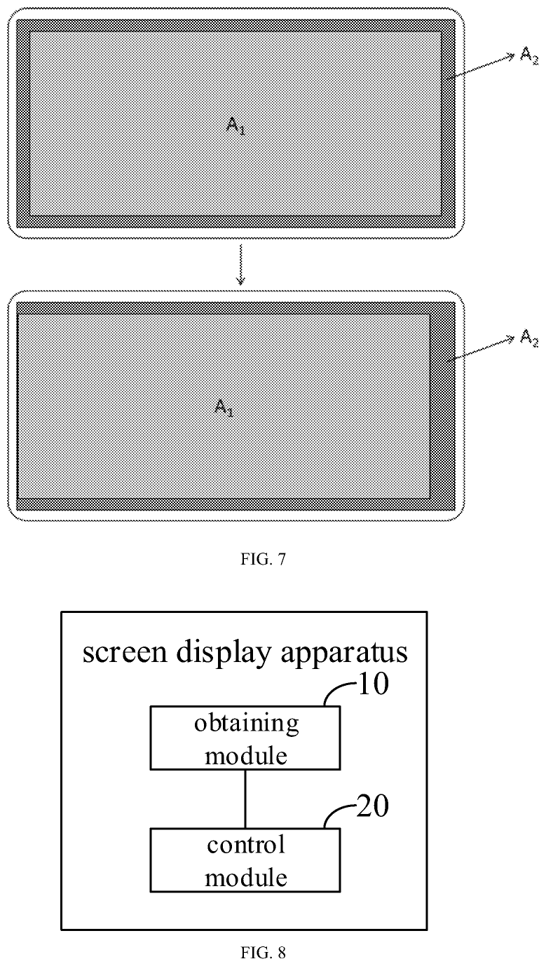

Exemplarily, referring to FIG. 6, a resolution of the target display screen is X*Y, which means that all pixels X*Y are occupied during full-screen display. Further, based on a preset interface design of the target display screen, the display region is divided to obtain a plurality of first display regions (D₁-D₅). The remaining unoccupied pixels constitute a second display region D₆. Further, dynamically obtaining the display image of any first display region of the target display screen, and executing the step of controlling the display image to move toward the second display region of the target display screen in response to determining that the display image satisfies a preset static image movement condition.

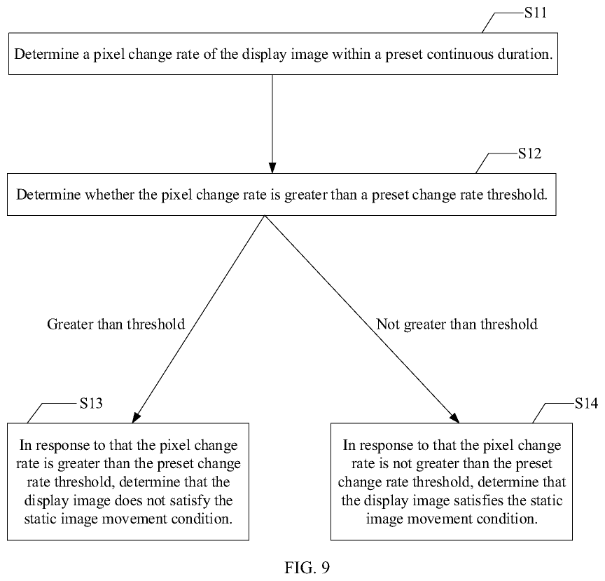

In a feasible implementation mode, before step S20, controlling the display image to move toward the second display region of the target display screen in response to determining that the display image satisfies the preset static image movement condition, the method further includes following steps as shown in FIG. 9.

Step S11, determining a pixel change rate of the display image within a preset continuous duration.

In a feasible embodiment, the pixel change rate of the display image within the preset continuous duration is calculated. The pixel change rate may be an average value of change rates of current frame pixel values of respective pixels in the display image relative to historical frame pixel values.

In an embodiment, the method further includes calculating an average value of adjacent frame pixel value differences of respective pixels between adjacent frames within the preset continuous duration, to serve as a first change rate corresponding to each of the pixels of the display image; and determining an average value of first change rates of pixels included in the display image as the pixel change rate.

Step S12, determining whether the pixel change rate is greater than a preset change rate threshold.

Step S13, in response to that the pixel change rate is greater than the preset change rate threshold, determining that the display image does not satisfy the static image movement condition.

Step S14, in response to that the pixel change rate is not greater than the preset change rate threshold, determining that the display image satisfies the static image movement condition.

In a feasible embodiment, determining whether the pixel change rate of the display image is greater than the preset change rate threshold. When the pixel change rate of the display image is greater than the preset change rate threshold, it indicates that the pixels of the display image as a whole are in a process of dynamic change, that is, the brightness is constantly changing, and the probability of burn-in occurrence is relatively low, then it is determined that the display image does not satisfy the static image movement condition, and the step of dynamically obtaining the display image of the target display screen is performed. When the pixel change rate of the display image is not greater than the preset change rate threshold, it indicates that the pixels of the display image as a whole are in a relatively still state, and at least some pixels stay lit for a long time and the brightness remains unchanged. If this is maintained continuously, the target display screen may experience a burn-in situation, that is, there is a burn-in risk. Then, it is determined that the display image satisfies the static image movement condition.

In this embodiment, the pixel change rate of the display image within the preset continuous duration is determined, to further determine whether the pixel change rate is greater than the preset change rate threshold. When the pixel change rate is greater than the preset change rate threshold, it indicates that the pixels of the display image as a whole are in a process of dynamic change, and the probability of burn-in occurrence is relatively low, then to determine that the display image does not satisfy the static image movement condition. When the pixel change rate is not greater than the preset change rate threshold, it indicates that the pixels of the display image as a whole are in a relatively still state and there is a burn-in risk, then to determine that the display image satisfies the static image movement condition. Through the pixel change rate of the display image, the determination accuracy for the burn-in risk of the target display screen is improved, and corresponding measures can be executed in a timely manner to avoid the burn-in phenomenon at the vehicle-mounted display screen.

Step S20, in response to determining that the display image satisfies the preset static image movement condition, controlling the display image to move toward a second display region of the target display screen. The second display region includes a plurality of unoccupied pixels configured to display the display image.

In a feasible embodiment, the static image movement condition includes: the pixel change rate of the display image within the preset continuous duration is less than or equal to the preset change rate threshold. If the pixel change rate of the display image within the preset continuous duration is less than or equal to the preset change rate threshold, then the display image satisfies the static image movement condition. Further, controlling the display image to move toward the unoccupied pixel region (the second display region) reserved in the target display screen, so as to achieve pixel-level jumping of the display image within the target display screen.

Exemplarily, referring to FIG. 7, in response to determining that the display image A₁ satisfies the preset static image movement condition, controlling the display image A₁ to move toward the second display region A₂ of the target display screen, so that the display image A₁ moves from a center of the target display screen toward the left side.

It should be understood that, since the target display screen is a vehicle-mounted display screen provided at a vehicle, a viewer located inside the vehicle may not necessarily concentrate on watching the target display screen for a long time. That is, the viewer's sensitivity to the display image of the vehicle-mounted display screen will be far lower than that of devices such as televisions and computers. Therefore, when the display image satisfies the preset static image movement condition, when controlling the display image to move, if the movement speed is set properly, the user's viewing experience will not be affected.

In this embodiment, through the pre-division of the display regions of the vehicle-mounted display screen, an actual display region (namely, the first display region) configured to display the display image, as well as a to-be-displayed region (namely, the second display region) similarly capable of being configured to display the display image but with unoccupied pixels, are obtained. Further, in response to determining that the display image satisfies the preset static image movement condition, that is, when at least a part of the static image exists in the display image and there is a certain burn-in risk, automatically controlling the display image to move toward the second display region reserved in the target display screen. Since one of the reasons for the burn-in situation of the OLED display screen is that the pixel dots at the display screen stay lit for a long time and the brightness remains unchanged, thereby resulting in different brightness decay degrees of each pixel dot at the display screen. Therefore, through the pre-division of regions, a movable region is provided for the display image. Further, when a burn-in risk exists, that is, the preset static image movement condition is satisfied, the display image is controlled to move within the second display region of the target display screen; so that at least some pixels of the target display screen have a change in brightness caused by the movement, thereby effectively avoiding the occurrence of the burn-in situation of the display screen.

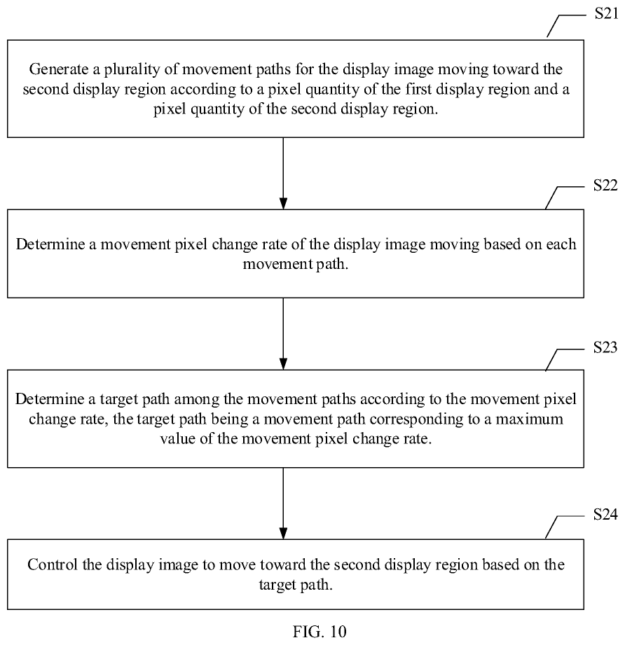

Further, based on the first embodiment, a second embodiment of the screen display method of the present application is provided. In this embodiment, step S20, controlling the display image to move toward the second display region of the target display screen includes following steps as shown in FIG. 10.

Step S21, generating a plurality of movement paths for the display image moving toward the second display region according to a pixel quantity of the first display region and a pixel quantity of the second display region.

In a feasible embodiment, in order to avoid the occurrence of a display screen burn-in situation through page movement; generating a plurality of paths (hereinafter referred to as movement paths for differentiation) for the display image to move toward the second display region according to the numbers of pixels included in the first display region and the second display region.

In an embodiment, the movement path includes a path of the display image moving within the second display region.

Step S22, determining a movement pixel change rate of the display image moving based on each movement path.

Step S23, determining a target path among the movement paths according to the movement pixel change rate, the target path being a movement path corresponding to a maximum value of the movement pixel change rate.

Step S24, controlling the display image to move toward the second display region based on the target path.

In a feasible embodiment, after generating the plurality of movement paths, it is further necessary to select a suitable target path from the plurality of movement paths; then, simulate and calculate the movement pixel change rate of the display image when moving based on each movement path; then determine the movement path corresponding to the maximum value of the movement pixel change rate as the target path. If the plurality of movement paths have the same movement pixel change rate and all are the maximum value, then any one of the movement paths is selected as the target path. Control the display image to move toward the second display region based on the target path.

In this embodiment, through generating the plurality of movement paths for the display image moving toward the second display region according to the pixel quantities of the first display region and the second display region; and then determining the movement pixel change rate of the display image moving based on each movement path; further, according to the movement pixel change rate, a suitable target path is selected from the plurality of movement paths, which is the movement path corresponding to the maximum value of the movement pixel change rate; and then controlling the display image to move toward the second display region based on the target path; so that when the display image moves based on the target path, the pixels of the target display screen can be changed to the greatest extent, thereby further reducing the occurrence probability of the burn-in situation of the vehicle-mounted display screen.

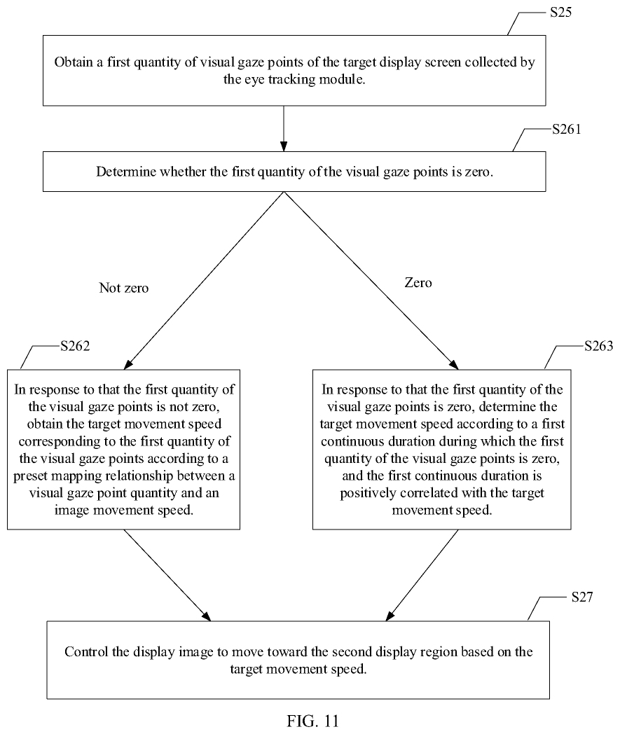

In a feasible implementation mode, the target display screen is provided with an eye tracking module. Step S20, controlling the display image to move toward the second display region of the target display screen includes following steps as shown in FIG. 11.

Step S25, obtaining a first quantity of visual gaze points of the target display screen collected by the eye tracking module.

In a feasible embodiment, each vehicle-mounted display screen is provided with an eye tracking module, which is configured to collect a visual gaze point generated at the vehicle-mounted display screen when a user gazes at the vehicle-mounted display screen; and obtaining the first quantity of visual gaze points of the target display screen collected by the eye tracking module.

Step S26, determining a target movement speed of the display image according the first quantity of the visual gaze points. The first quantity of the visual gaze points is negatively correlated with the target movement speed.

In a feasible embodiment, according to the first quantity of visual gaze points of the target display screen, determining a suitable target movement speed during the movement of the display image. The first quantity of the visual gaze points is negatively correlated with the target movement speed. Because the more the visual gaze points of the target display screen are, the more users are indicated to be gazing at the target display screen. If it moves fast at this time, the visual experience of the users will be affected; therefore, the movement speed of the display image needs to be reduced. If the visual gaze points of the target display screen are fewer, it indicates that the user may not be focusing on the display image of the target display screen at this time. Then at this time, the display image is controlled to speed up the movement speed, so that the pixels of the target display screen generate a brightness change, thereby reducing the burn-in risk of the display screen.

In a feasible implementation mode, step S26, determining the target movement speed of the display image according to the first quantity of the visual gaze points includes:
Step S261, determining whether the first quantity of the visual gaze points is zero;
Step S262, when the first quantity of the visual gaze points is not zero, obtaining the target movement speed corresponding to the first quantity of the visual gaze points according to a preset mapping relationship between a visual gaze point quantity and an image movement speed; and
Step S263, when the first quantity of the visual gaze points is zero, determining the target movement speed according to a first continuous duration during which the first quantity of the visual gaze points is zero. The first continuous duration is positively correlated with the target movement speed.

In a feasible embodiment, whether the first quantity of visual gaze points of the target display screen is zero is determined. When the first quantity of the visual gaze points is not zero, it indicates that there are still some users currently gazing at the target display screen, then obtaining the target movement speed corresponding to the first quantity of the visual gaze points according to a preset mapping relationship between a visual gaze point quantity and an image movement speed. When the first quantity of the visual gaze points is zero, it indicates that no user is gazing at the target display screen at this time, but this may be because the user needs to observe traffic conditions during vehicle driving and briefly shifts his/her sight from the target display screen. If the display screen is moved rapidly immediately, it may still affect the viewing experience of the user. Therefore, further obtaining the first continuous duration during which the first quantity of visual gaze points is zero, and determining the target movement speed according to the first continuous duration. The first continuous duration is positively correlated with the target movement speed. When the first continuous duration is relatively short, the display image is controlled to move at a lower speed to cope with the scenario where the user merely briefly does not gaze at the target display screen. As the first continuous duration during which the first quantity of the visual gaze points is zero continues to increase, it indicates that the user is not briefly shifting his/her sight, but has no usage requirement for the target display screen within a certain period of time. Then the movement speed of the display image is increased to achieve a better effect of avoiding the occurrence of the display screen burn-in situation.

In an embodiment, determining the target movement speed according to the first continuous duration during which the first quantity of the visual gaze points is zero includes: determining a target duration interval among preset duration intervals in which the first continuous duration is located; taking a movement speed associated with the target duration interval as the target movement speed.

In an embodiment, determining the target movement speed according to the first continuous duration during which the first quantity of the visual gaze points is zero includes: obtaining the target movement speed corresponding to the first continuous duration according to a preset mapping relationship between a zero-gaze continuous duration and the image movement speed.

Step S27, controlling the display image to move toward the second display region based on the target movement speed.

In a feasible embodiment, after determining the target movement speed, controlling the display image to move toward the second display region at the target movement speed.

In this embodiment, based on a vehicle-mounted scenario of the vehicle-mounted display screen, a viewing user of the vehicle-mounted display screen has a lower sensitivity to the display image in the display screen than to other display devices, such as televisions and computers. Therefore, when controlling the display image to move, the target movement speed can be determined through the first quantity of the visual gaze points of the target display screen collected by the eye tracking module. The first quantity of the visual gaze points is negatively correlated with the target movement speed. Thus, on the basis of ensuring the user's use experience, the occurrence of the burn-in phenomenon of the display screen is effectively avoided.

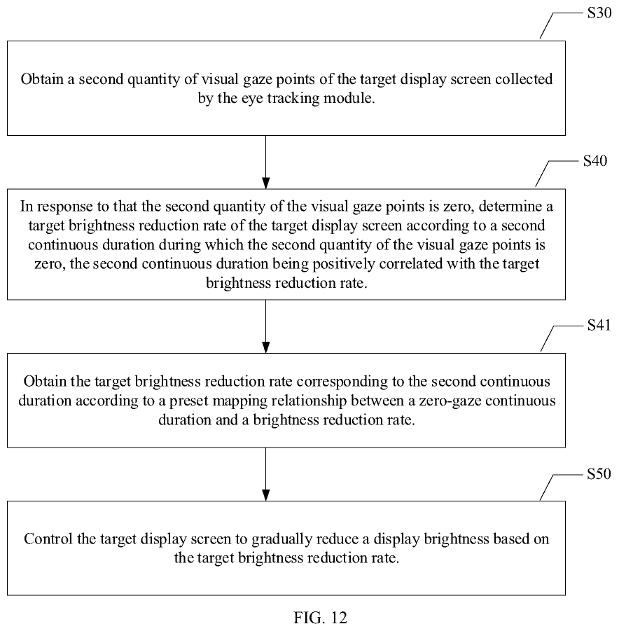

Further, based on the above first and/or second embodiments, a third embodiment of the screen display method of the present application is provided. In this embodiment, the target display screen is provided with an eye tracking module. After Step S20, controlling the display image to move toward the second display region of the target display screen, the method further includes following steps as shown in FIG. 12.

Step S30, obtaining a second quantity of visual gaze points of the target display screen collected by the eye tracking module.

In a feasible embodiment, each vehicle-mounted display screen is provided at an eye tracking module, which is configured to collect a visual gaze point generated at the vehicle-mounted display screen when a user gazes at the vehicle-mounted display screen. After controlling the display image to move, continuing to obtain the second quantity of the visual gaze points of the target display screen collected by the eye tracking module.

Step S40, when the second quantity of the visual gaze points is zero, determining a target brightness reduction rate of the target display screen according to a second continuous duration during which the second quantity of the visual gaze points is zero. The second continuous duration is positively correlated with the target brightness reduction rate.

Since long-term high brightness of the display screen is also one of the causes the burn-in phenomenon of the display screen, therefore, the display brightness can be properly reduced according to the user's usage situation of the display screen, to avoid the occurrence of the display screen burn-in situation. In order to avoid affecting the user experience caused by the reduction of the display brightness, an automatic reduction of the target display screen brightness is performed when the second quantity of the visual gaze points is zero.

In a feasible embodiment, when the second quantity of the visual gaze points i zero, then determining a target brightness reduction rate of the target display screen according to the second continuous duration during which the second quantity of the visual gaze points is zero. The second continuous duration is positively correlated with the target brightness reduction rate.

In a feasible implementation mode, step S40, determining the target brightness reduction rate of the target display screen according to the second continuous duration during which the second quantity of the visual gaze points is zero includes:

Step S41, obtaining the target brightness reduction rate corresponding to the second continuous duration according to a preset mapping relationship between a zero-gaze continuous duration and a brightness reduction rate.

In a feasible embodiment, there is a preset mapping relationship between the zero-gaze continuous duration and the brightness reduction rate. The zero-gaze continuous duration is a continuous duration when the quantity of the visual gaze points of the display screen is zero. Based on the above mapping relationship, matching to obtain the target brightness reduction rate corresponding to the second continuous duration.

Step S50, controlling the target display screen to gradually reduce a display brightness based on the target brightness reduction rate.

In a feasible embodiment, after a suitable target brightness reduction rate is determined, controlling the target display screen to gradually reduce the display brightness based on the target brightness reduction rate.

In an embodiment, the target display screen is provided with a temperature sensor; and display temperature data of the target display screen collected by the temperature sensor is dynamically obtained. If the display temperature data is greater than a preset temperature threshold, a brightness upper limit of a display of the target display screen is reduced. Since high temperature is one of the reasons for generating the burn-in phenomenon at the display screen, and the installation positions of the vehicle-mounted display screens in a vehicle are different, environmental temperatures during usage will also have certain differences. Thus, based on the temperature data collected by the temperature sensor of each display screen, targeted adjustment is performed on the display brightness upper limit of the display screen.

In an embodiment, a display mode of the target display screen is obtained. If t display mode is a night mode or a dark mode, a brightness upper limit of a display of the target display screen is reduced. Since a significant grayscale adjacency difference is one of the causes leading to the occurrence of the burn-in phenomenon of the display screen, therefore, after the target display screen enters the night mode or the dark mode, the occurrence of the burn-in situation is effectively avoided by reducing the display brightness upper limit of the target display screen.

In this embodiment, in order to further avoid the occurrence of the burn-in phenomenon, an automatic adjustment of the display brightness is performed on the display screen that is not being watched. Furthermore, the display brightness of the target display screen is not directly reduced to the minimum display brightness, but gradually reduced, thereby capable of effectively improving the user's use experience. Further, in the process of gradually reducing the display screen brightness, the zero-gaze continuous duration of the target display screen is positively correlated with the brightness reduction rate. That is, when the display brightness of the target display screen starts to be reduced, an overall brightness variation amount is relatively small. Thus, it can effectively avoid a situation where the brightness of the display screen reduces too much in a short time, resulting in a long recovery time waiting when the user intends to use it. On the basis of ensuring the user's perception of use, the occurrence of the burn-in situation of the vehicle-mounted display screen is effectively avoided.

Further, an embodiment of the present application also provides a screen display apparatus. Referring to FIG. 8, the screen display apparatus is applied to an electronic device, and the screen display apparatus includes: an obtaining module 10 and a control module 20.

The obtaining module 10 is configured to dynamically obtain a display image of a target display screen. The display image is displayed in a first display region of the target display screen.

The control module 20 is configured to control the display image to move toward a second display region of the target display screen in response to determining that the display image satisfies a preset static image movement condition. The second display region includes a plurality of unoccupied pixels configured to display the display image.

In an embodiment, the obtaining module 10 is further configured to determine pixel change rate of the display image within a preset continuous duration; determine whether the pixel change rate is greater than a preset change rate threshold; when the pixel change rate is greater than a preset change rate threshold, determine that the display image does not satisfy the static image movement condition; when the pixel change rate is not greater than a preset change rate threshold, determine that the display image satisfies the static image movement condition.

In an embodiment, the control module 20 is further configured to generate a plurality of movement paths for the display image moving toward the second display region according to a pixel quantity of the first display region and a pixel quantity of the second display region; determine a movement pixel change rate of the display image moving based on each movement path; determine a target path among the movement paths according to the movement pixel change rate. The target path is a movement path corresponding to a maximum value of the movement pixel change rate. The control module 20 is configured to control the display image to move toward the second display region based on the target path.

In an embodiment, the control module 20 is further configured to obtain a first quantity of visual gaze points of the target display screen collected by an eye tracking module; determine a target movement speed of the display image according to the first quantity of the visual gaze points. The first quantity of the visual gaze points is negatively correlated with the target movement speed. The control module 20 is configured to control the display image to move toward the second display region based on the target movement speed.

In an embodiment, the control module 20 is further configured to determine whether the first quantity of the visual gaze points is zero; when the first quantity of the visual gaze points is not zero, obtain the target movement speed corresponding to the first quantity of the visual gaze points according to a preset mapping relationship between a visual gaze point quantity and an image movement speed; when the first quantity of the visual gaze points is zero, determine the target movement speed according to a first continuous duration during which the first quantity of the visual gaze points is zero. The first continuous duration is positively correlated with the target movement speed.

In an embodiment, the control module 20 is further configured to obtain a second quantity of visual gaze points of the target display screen collected by an eye tracking module; when the second quantity of the visual gaze points is zero, determine a target brightness reduction rate of the target display screen according to a second continuous duration during which the second quantity of the visual gaze points is zero. The second continuous duration is positively correlated with the target brightness reduction rate. The control module 20 is configured to control the target display screen to gradually reduce a display brightness based on the target brightness reduction rate.

In an embodiment, the control module 20 is further configured to obtain the target brightness reduction rate corresponding to the second continuous duration according to a preset mapping relationship between a zero-gaze continuous duration and a brightness reduction rate.

Specific implementation modes of the screen display apparatus in the present application are basically the same as those of the various embodiments of the screen display method described above, and are not repeated herein.

It should be noted that in this context, terms “include”, “contain”, or any other variants thereof are intended to cover non-exclusive inclusions, such that a process, method, article, or system including a series of elements includes not only those elements but also other elements not explicitly listed, or further includes elements inherent to such process, method, article, or system. In a condition of no more limitations, an element restricted by the sentence “include one . . . ” does not exclude the existence of additional identical elements in the process, method, article, or system including the element.

Through the description of the above implementation modes, a person skilled in the art can clearly understand that the methods in the above embodiments can be implemented by means of software plus a necessary universal hardware platform, and certainly can also be implemented through hardware, but in many cases, the former is a better implementation mode. Based on such an understanding, the technical solutions of the present application essentially, or the part contributing to the related art, can be embodied in the form of a software product. This computer software product is stored in a storage medium as described above (such as a ROM/RAM, a magnetic disk, an optical disc), including a number of instructions configured to cause a terminal device (which can be a mobile phone, a computer, a server, or a network device, etc.) to execute the methods described in various embodiments of the present application.

The above are merely some embodiments of the present application, and thus are not intended to limit the scope of the present application. Equivalent structures or equivalent process transformations made by utilizing the contents of the specification and drawings of the present application, or direct or indirect application in other related technical fields, are similarly included within the scope of the present application.

What is claimed is:

1. A screen display method, applied to a vehicle-mounted display screen, comprising:
dynamically obtaining a display image of a target display screen, wherein the display image is displayed in a first display region of the target display screen; and
controlling the display image to move toward a second display region of the target display screen in response to determining that the display image satisfies a preset static image movement condition, wherein the second display region comprises a plurality of unoccupied pixels for displaying the display image.

2. The screen display method according to claim 1, wherein before the controlling the display image to move toward the second display region of the target display screen in response to determining that the display image satisfies the preset static image movement condition, the method further comprises:
determining a pixel change rate of the display image within a preset continuous duration;
determining whether the pixel change rate is greater than a preset change rate threshold;
in response to that the pixel change rate is greater than the preset change rate threshold, determining that the display image does not satisfy the static image movement condition; and
in response to that the pixel change rate is not greater than the preset change rate threshold, determining that the display image satisfies the static image movement condition.

3. The screen display method according to claim 2, wherein the pixel change rate is an average value of change rates of current frame pixel values of each pixel in the display image relative to historical frame pixel values.

4. The screen display method according to claim 2, wherein the determining the pixel change rate of the display image within the preset continuous duration comprises:
calculating an average value of adjacent frame pixel value differences of each pixel between adjacent frames within the preset continuous duration, to serve as a first change rate corresponding to each pixel of the display image; and
determining an average value of first change rates of pixels comprised in the display image as the pixel change rate.

5. The screen display method according to claim 1, wherein the controlling the display image to move toward the second display region of the target display screen comprises:
generating a plurality of movement paths for the display image moving toward the second display region according to a pixel quantity of the first display region and a pixel quantity of the second display region;
determining a movement pixel change rate of the display image moving based on each movement path;
determining a target path among the movement paths according to the movement pixel change rate, wherein the target path is a movement path corresponding to a maximum value of the movement pixel change rate; and
controlling the display image to move toward the second display region based on the target path.

6. The screen display method according to claim 1, wherein the target display screen is provided with an eye tracking module, and the controlling the display image to move toward the second display region of the target display screen comprises:
obtaining a first quantity of visual gaze points of the target display screen collected by the eye tracking module;
determining a target movement speed of the display image according to the first quantity of the visual gaze points, wherein the first quantity of the visual gaze points is negatively correlated with the target movement speed; and
controlling the display image to move toward the second display region based on the target movement speed.

7. The screen display method according to claim 6, wherein the determining the target movement speed of the display image according to the first quantity of the visual gaze points comprises:
determining whether the first quantity of the visual gaze points is zero;
in response to that the first quantity of the visual gaze points is not zero, obtaining the target movement speed corresponding to the first quantity of the visual gaze points according to a preset mapping relationship between a visual gaze point quantity and an image movement speed; and
in response to that the first quantity of the visual gaze points is zero, determining the target movement speed according to a first continuous duration during which the first quantity of the visual gaze points is zero, and the first continuous duration is positively correlated with the target movement speed.

8. The screen display method according to claim 7, wherein the determining the target movement speed according to the first continuous duration during which the first quantity of the visual gaze points is zero comprises:
determining a target duration interval among preset duration intervals in which the first continuous duration is located; and taking a movement speed associated with the target duration interval as the target movement speed.

9. The screen display method according to claim 7, wherein the determining the target movement speed according to the first continuous duration during which the first quantity of the visual gaze points is zero comprises:
obtaining the target movement speed corresponding to the first continuous duration according to a preset mapping relationship between a zero-gaze continuous duration and the image movement speed.

10. The screen display method according to claim 1, wherein the target display screen is provided with an eye tracking module, and after the controlling the display image to move toward the second display region of the target display screen, the method further comprises:
obtaining a second quantity of visual gaze points of the target display screen collected by the eye tracking module;
in response to that the second quantity of the visual gaze points is zero, determining a target brightness reduction rate of the target display screen according to a second continuous duration during which the second quantity of the visual gaze points is zero, wherein the second continuous duration is positively correlated with the target brightness reduction rate; and
controlling the target display screen to gradually reduce a display brightness based on the target brightness reduction rate.

11. The screen display method according to claim 10, wherein the determining the target brightness reduction rate of the target display screen according to the second continuous duration during which the second quantity of the visual gaze points is zero comprises:
obtaining the target brightness reduction rate corresponding to the second continuous duration according to a preset mapping relationship between the zero-gaze continuous duration and a brightness reduction rate.

12. The screen display method according to claim 10, wherein the target display screen is provided with a temperature sensor; and the method further comprises:
reducing a brightness upper limit of a display of the target display screen in response to that display temperature data is greater than a preset temperature threshold.

13. The screen display method according to claim 10, wherein after the controlling the target display screen to gradually reduce the display brightness, the method further comprises:
obtaining a display mode of the target display screen; and
reducing a brightness upper limit of a display of the target display screen in response to that the display mode is a night mode or a dark mode.

14. A screen display apparatus, comprising:
an obtaining module configured to dynamically obtain a display image of a target display screen, wherein the display image is displayed in a first display region of the target display screen; and
a control module configured to control the display image to move toward a second display region of the target display screen in response to determining that the display image satisfies a preset static image movement condition, wherein the second display region comprises a plurality of unoccupied pixels for displaying the display image.

15. An electronic device, comprising: a memory, a processor, and a screen display program stored in the memory and executable on the processor, wherein the screen display program is configured to implement the screen display method according to claim 1.

16. A non-transitory computer-readable storage medium, wherein a screen display program is stored in the storage medium, and the screen display program, when executed by a processor, implements the screen display method according to claim 1.
